(19) United States
(12) Patent Application Publication
(10) Pub. No.: US 2017/0272247 A1
(43) Pub. Date: Sep. 21, 2017

(54) ENCRYPTION SETUP VERIFICATION

(71) Applicant: Telefonaktiebolaget LM Ericsson (publ), Stockholm (SE)

(72) Inventors: Petri Mikael JOHANSSON, Bjarred (SE); Lina Charlotta PALSSON, Genarp (SE)

(21) Appl. No.: 15/304,523

(22) PCT Filed: Nov. 20, 2015
(86) PCT No.: PCT/EP2015/077211

§ 371 Date: Oct. 15, 2016

(51) Int. Cl. H04L 9/30; H04L 9/32; H04L 9/08; H04L 9/14; G06F 9/44; G06F 21/57

(52) U.S. Cl. CPC H04L 9/30; G06F 9/4406; G06F 21/575; H04L 9/0861; H04L 9/0819; H04L 9/14; H04L 9/3247; H04L 2209/127

(57) ABSTRACT

There is provided mechanisms for verifying setup of encryption of a block of data. The method is performed by a client node. A method comprises obtaining an indication to encrypt the block of data. The method comprises providing a first message to a compute node indicating a setup request of a block storage volume, V, to be encrypted, wherein the first message comprises a nonce, N. The method comprises obtaining a second message from the compute node, wherein the second message comprises the nonce, N, and provides validation that a key management node has taken part in setup of the encryption of the block of data and a cryptographic measurement of the compute node, including evidence that the compute node is in a trusted state according to the key management node. There is also provide such a client node. There is further provided a compute node and a method performed by the compute node. There is further provided a key management node and a method performed by the key management node.

### TECHNICAL FIELD

Embodiments presented herein relate to methods, a client node, a compute node, a key management node, computer programs, and a computer program product for verifying setup of encryption of a block of data.

### BACKGROUND

In communications networks, there may be a challenge to obtain good performance and capacity for a given communications protocol, its parameters and the physical environment in which the communications network is deployed.

For example, one parameter in providing good performance and capacity for a given communications protocol in a communications network is the ability to provide secure communications and secure data storage.

Currently, some computational cloud platforms provide secure storage via a Linux Unified key setup (LUKS) volume encryption process running on a compute node. The compute node itself can be secured using concepts like Trusted Compute Pools and Trusted Platform Modules.

Trusted Platform Modules based technologies can be used to increase security in computational cloud platform environments. One drawback is that these technologies do not provide transparency to the end-users (as represented by client nodes). Particularly, there is currently very limited (or even non-existing) means for the end user to obtain any kind of proof that data stored on an encrypted volume storage actually is encrypted. The encryption is performed by the compute node before the data is sent to a storage node. Nor is any proof provided that the compute node is secured with a TPM and that a trusted boot has been performed.

Hence, there is still a need for an improved handling of encryption of a block of data.

### SUMMARY

An object of embodiments herein is to provide efficient setup for encryption of a block of data.

According to a first aspect there is presented a method for verifying setup of encryption of a block of data. The method is performed by a client node. The method comprises obtaining an indication to encrypt the block of data. The method comprises providing a first message to a compute node indicating a setup request of a block storage volume, V, to be encrypted, wherein the first message comprises a nonce, N. The method comprises obtaining a second message from the compute node, wherein the second message comprises the nonce, N, arid provides validation that a key management node has taken part in setup of the encryption of the block of data and a cryptographic measurement of the compute node, including evidence that the compute node is in a trusted state according to the key management node.

According to a second aspect there is presented a client node for verifying setup of encryption of a block of data. The client node comprises processing circuitry. The processing circuitry is configured to cause the client node to obtain an indication to encrypt the block of data. The processing circuitry is configured to cause the client node to provide a first message to a compute node indicating a setup request of a block storage volume, V, to be encrypted, wherein the first message comprises a nonce, N. The processing circuitry is configured to cause the client node to obtain a second message from the compute node, wherein the second message comprises the nonce, N, and provides validation that a key management node has taken part in setup of the encryption of the block of data and a cryptographic measurement of the compute node, including evidence that the compute node is in a trusted state according to the key management node.

According to a third aspect there is presented a client node for verifying setup of encryption of a block of data. The client node comprises processing circuitry. The client node comprises a computer program product. The computer program product stores instructions that, when executed by the processing circuitry, causes the client node to perform a set of operations, or steps. The operations comprise providing a first message to a compute node indicating a setup request of a block storage volume, V, to be encrypted, wherein the first message comprises a nonce, N. The operations comprise obtaining a second message from the compute node, wherein the second message comprises the nonce, N, and provides validation that a key management node has taken part in setup of the encryption of the block of data and a cryptographic measurement of the compute node, including evidence that the compute node is in a trusted state according to the key management node.

According to a fourth aspect there is presented a client node for verifying setup of encryption of a block of data. The client node comprises an obtain module configured to obtain an indication to encrypt the block of data. The client node comprises a provide module configured to provide a first message to a compute node indicating a setup request of a block storage volume, V, to be encrypted, wherein the first message comprises a nonce, N. The obtain module is further configured to obtain a second message from the compute node, wherein the second message comprises the nonce, N, and provides validation that a key management node has taken part in setup of the encryption of the block of data and a cryptographic measurement of the compute node, including evidence that the compute node is in a trusted state according to the key management node.

According to a fifth aspect there is presented a computer program for verifying setup of encryption of a block of data, the computer program comprising computer program code which, when run on processing circuitry of a client node, causes the client node to perform a method according to the first aspect.

According to a sixth aspect there is presented a method for verifying setup of encryption of a block of data. The method is performed by a compute node. The method comprises obtaining a first message from a client node, wherein the first message indicates a setup request of a block storage volume, V, to be encrypted, and wherein the first message comprises a nonce, N. The method comprises providing a third message to a key management node, wherein the third message comprises the nonce, N, a unique data storage identity of the block storage volume, V, to be encrypted, and a unique user identity of the client node. The method comprises obtaining a fourth message from the key management node, wherein the fourth message comprises the nonce, N, and an encrypted data storage key, In X. The method comprises providing a second message to the client node, wherein the second message comprises the nonce, N, and provides validation that the key management node has taken part in setup of the encryption of the block of data and a cryptographic measurement of the compute node, including evidence that the compute node is in a trusted state according to the key management node.

According to a seventh aspect there is presented a compute node for verifying setup of encryption of a block of data. The compute node comprises processing circuitry. The processing circuitry is configured to cause the compute node to obtain a first message from a client node, wherein the first message indicates a setup request of a block storage volume, V, to be encrypted, and wherein the first message comprises a nonce, N. The processing circuitry is configured to cause the compute node to provide a third message to a key management node, wherein the third message comprises the nonce, N, a unique data storage identity of the block storage volume, V, to be encrypted, and a unique user identity of the client node. The processing circuitry is configured to cause the compute node to obtain a fourth message from the key management node, wherein the fourth message comprises the nonce, N, and an encrypted data storage key, U^{VX}. The processing circuitry is configured to cause the compute node to provide a second message to the client node, wherein the second message comprises the nonce, N, and provides validation that the key management node has taken part in setup of the encryption of the block of data and a cryptographic measurement of the compute node, including evidence that the compute node is in a trusted state according to the key management node.

According to an eighth aspect there is presented a compute node for verifying setup of encryption of a block of data. The compute node comprises processing circuitry. The compute node comprises a computer program product. The computer program product stores instructions that, when executed by the processing circuitry, causes the compute node to perform a set of operations, or steps. The operations comprise obtaining a first message from a client node, wherein the first message indicates a setup request of a block storage volume, V, to be encrypted, and wherein the first message comprises a nonce, N. The operations comprise providing a third message to a key management node, wherein the third message comprises the nonce, N, a unique data storage identity of the block storage volume, V, to he encrypted, and a unique user identity of the client node. The operations comprise obtaining a fourth message from the key management node, wherein the fourth message comprises the nonce, N, and an encrypted data storage key, U^{VX}. The operations comprise providing a second message to the client node, wherein the second message comprises the nonce, N, and provides validation that the key management node has taken part in setup of the encryption of the block of data and a cryptographic measurement of the compute node, including evidence that the compute node is in a trusted state according to the key management node.

According to a ninth aspect there is presented a compute node for verifying setup of encryption of a block of data. The compute node comprises an obtain module configured to obtain a first message from a client node, wherein the first message indicates a setup request of a block storage volume, V, to be encrypted, and wherein the first message comprises a nonce, N. The compute node comprises a provide module configured to provide a third message to a key management node, wherein the third message comprises the nonce, N, a unique data storage identity of the block storage volume, V, to be encrypted, and a unique user identity of the client node. The obtain module is further configured to obtain a fourth message from the key management node, wherein the fourth message comprises the nonce, N, and an encrypted data storage key, U^{VX}. The provide module is further configured to provide a second message to the client node, wherein the second message comprises the nonce, N, and provides validation that the key management node has taken part in setup of the encryption of the block of data and a cryptographic measurement of the compute node, including evidence that the compute node is in a trusted state according to the key management node.

According to a tenth aspect there is presented a computer program for verifying setup of encryption of a block of data, the computer program comprising computer program code which, when run on processing circuitry of a compute node, causes the compute node to perform a method according to the sixth aspect.

According to an eleventh aspect there is presented a method for verifying setup of encryption of a block of data. The method is performed by a key management node. The method comprises obtaining a third message from a compute node, wherein the third message comprises a nonce, N, of a client node, a unique data storage identity of a block storage volume, V, to be encrypted, and a unique user identity of the client node. The method comprises providing a fourth message to the compute node, wherein the fourth message comprises the nonce, N, and an encrypted data storage key, U^{VX}.

According to a twelfth aspect there is presented a key management node for verifying setup of encryption of a block of data. The key management node comprises processing circuitry. The processing circuitry is configured to cause the key management node to obtain a third message from a compute node, wherein the third message comprises a nonce, N, of a client node, a unique data storage identity of a block storage volume, V, to be encrypted, and a unique user identity of the client node The processing circuitry is configured to cause the key management node to provide a fourth message to the compute node, wherein the fourth message comprises the nonce, N, and an encrypted data storage key, U^{VX}.

According to a thirteenth aspect there is presented a key management node for verifying setup of encryption of a block of data. The key management node comprises processing circuitry. The key management node comprises a computer program product. The computer program product stores instructions that, when executed by the processing circuitry, causes the key management node to perform a set of operations, or steps. The operations comprise obtaining a third message from a compute node, wherein the third message comprises a nonce, N, of a client node, a unique data storage identity of a block storage volume, V, to be encrypted, and a unique user identity of the client node. The operations comprise providing a fourth message to the compute node, wherein the fourth message comprises the nonce, N, and an encrypted data storage key, U^{VX}.

According to a fourteenth aspect there is presented a key management node for verifying setup of encryption of a block of data. The key management node comprises an obtain module configured to obtain a third message from a compute node, wherein the third message comprises a nonce, N, of a client node, a unique data storage identity of a block storage volume, V, to be encrypted, and a unique user identity of the client node. The key management node comprises a provide module configured to provide a fourth message to the compute node, wherein the fourth message comprises the nonce, N, and an encrypted data storage key, U^{VX}.

According to a fifteenth aspect there is presented a computer program for verifying setup of encryption of a block of data, the computer program comprising computer program code which, when run on processing circuitry of a key management node, causes the key management node to perform a method according to the eleventh aspect.

According to a sixteenth aspect there is presented a computer program product comprising a computer program according to at least one of the fifth aspect, the tenth aspect, and the fifteenth aspect, and a computer readable storage medium on which the computer program is stored. The computer readable storage medium can be a non-transitory computer readable storage medium.

Advantageously these methods, this client node, this compute node, this key management node, these computer programs, and this computer program product provide efficient setup for encryption of a block of data.

Advantageously, the client node (and hence the end-user) will receive a proof that the compute node has been in communication with the key management node to obtain the storage key of the client node and that an encrypted volume has been attached.

Advantageously, the client node (and hence the end-user) can receive information of PCR register content on the compute node on which the encryption is performed, which makes it possible for the client node to analyze these values and compare them with whitelists.

Advantageously, this enables an encrypted volume to only be attached on an approved and trusted compute node.

Advantageously, this provides a secure distribution of volume encryption keys where the key is distributed encrypted to secure compute nodes.

It is to be noted that any feature of the first, second, third, fourth, fifth, sixth seventh, eight, ninth, tenth, eleventh, twelfth, thirteenth, fourteenth, fifteenth and sixteenth aspects may be applied to any other aspect, wherever appropriate. Likewise, any advantage of the first aspect may equally apply to the second, third, fourth, fifth, sixth, seventh., eight, ninth, tenth, eleventh, twelfth, thirteenth, fourteenth, fifteenth, and/or sixteenth aspect, respectively, and vice versa. Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, step, etc.” are to he interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIG. 1 is a schematic diagram illustrating a communication network according to embodiments;

FIG. 2a is a schematic diagram showing functional units of a client node according to an embodiment;

FIG. 2b is a schematic diagram showing functional modules of a client node according to an embodiment;

FIG. 3a is a schematic diagram showing functional units of a compute node according to an embodiment;

FIG. 3b is a schematic diagram showing functional modules of a compute node according to an embodiment;

FIG. 4a is a schematic diagram showing functional units of a key management node according to an embodiment;

FIG. 4b is a schematic diagram showing functional modules of a key management node according to an embodiment;

FIG. 5 shows one example of a computer program product comprising computer readable means according to an embodiment;

FIGS. 6, 7, 8, 9, and 10 are flowcharts of methods according to embodiments; and

FIG. 11 is a signalling diagram according to an embodiment.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

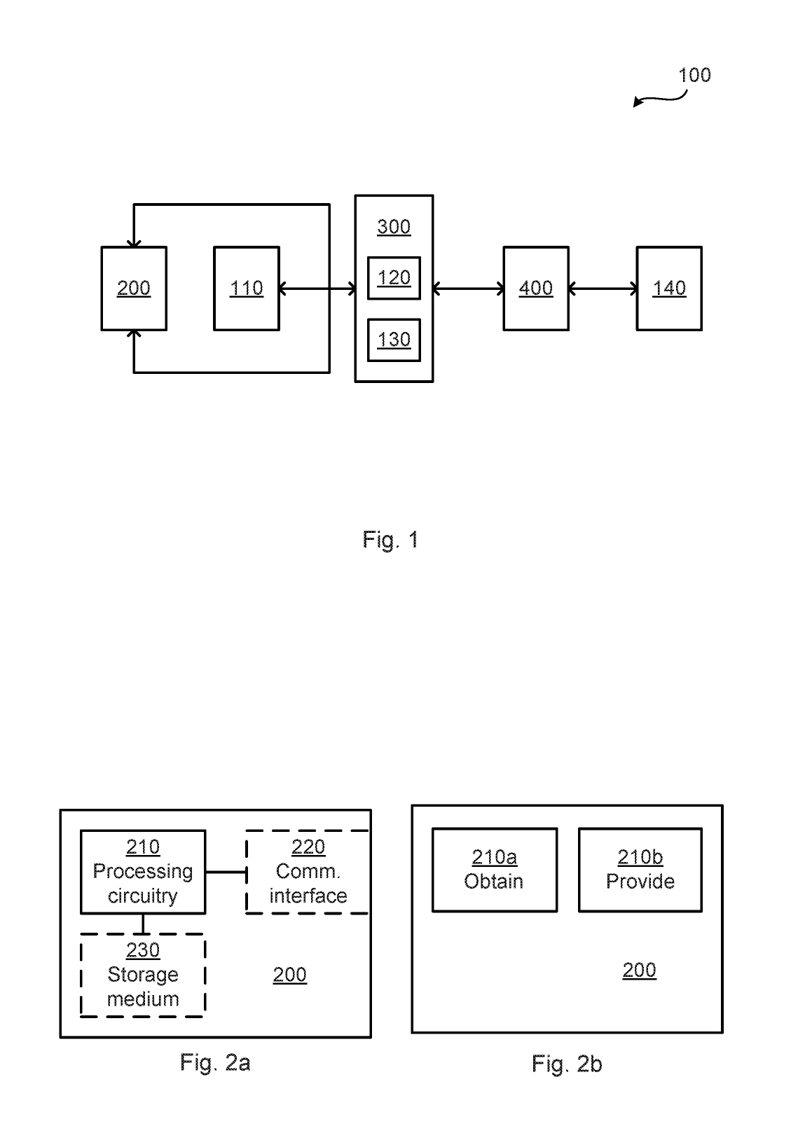

FIG. 1 is a schematic diagram illustrating a communications network 100 where embodiments presented herein can he applied. The communications network 100 comprises a client node 200, a compute node 300, a key management node 400, a block storage node 110, a trusted platform module 120 (co-located with, resided in, or at least operatively connected to, the compute node 300), a user block storage volume 130 (co-located with, resided in, or at least operatively connected to, the compute node 300), and a user identification node 140.

The client node 200 may be a wireless device, a mobile station, a mobile phone, a handset, a wireless local loop phone, a user equipment (UE), a mobile equipment, a smartphone, a laptop computer, a tablet computer, a wireless modem, or a sensor device. It may also be a more stationary device such as a telematics unit embedded in or attachable to a vehicle, such as a car, truck, bus, boat, train, airplane and flying drone. The client node 200 may also for example be embedded in or attachable to a domestic appliance, such as in white goods, door locks, surveillance and alarm equipment and autonomous vacuum cleaners and grass cutters. The client node 200 may also be embedded in or attachable telematics units for robots and 3D printers used for industrial purposes or for domestic support functions. Other examples of where the client node 200 may be incorporated or added to is in public service equipment, such as street lamps, surveillance cameras, entrance admittance equipment for public transport. The client node 200 may in other words be or be implemented in equipment which is able to utilize the wireless connectivity to the communications network 100. Further examples of such client nodes 200 are equipment used in healthcare and in payment terminals, e.g. payment terminals for credit cards.

It is assumed that the client node 200 has a need to securely store encrypted data.

The embodiments disclosed herein therefore relate to mechanisms for verifying setup of encryption of a block of data. In order to obtain such mechanisms there is provided a client node 200, a method performed by the client node 200, a computer program product comprising code, for example in the form of a computer program, that when run on processing circuitry of the client node 200, causes the client node 200 to perform the method. In order to obtain such mechanisms there is further provided a compute node 300, a method performed by the compute node 300, and a computer program product comprising code, for example in the form of a computer program, that when run on processing circuitry of the compute node 300, causes the compute node 300 to perform the method. In order to obtain such mechanisms there is further provided a key management node 400, a method performed by the key management node 400, and a computer program product comprising code, for example in the form of a computer program, that when run on processing circuitry of the key management node 400, causes the key management node 400 to perform the method.

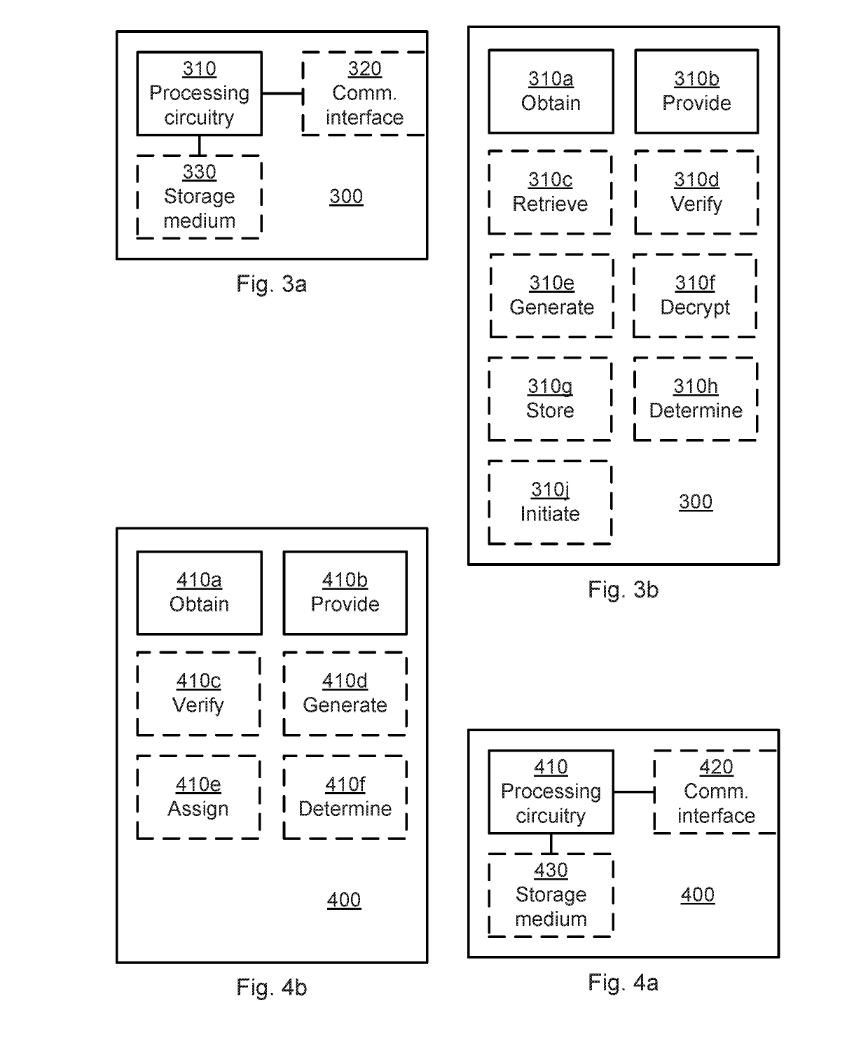

FIGS. 2a and 2b will be further described below and illustrate a client node 200 configured for verifying setup of encryption of a block of data. FIGS. 3a and 3b will be further described below and illustrate a compute node 300 configured for verifying setup of encryption of a block of data. FIGS. 4a and 4b will be further described below and illustrate a key management node 400 configured for verifying setup of encryption of a block of data.

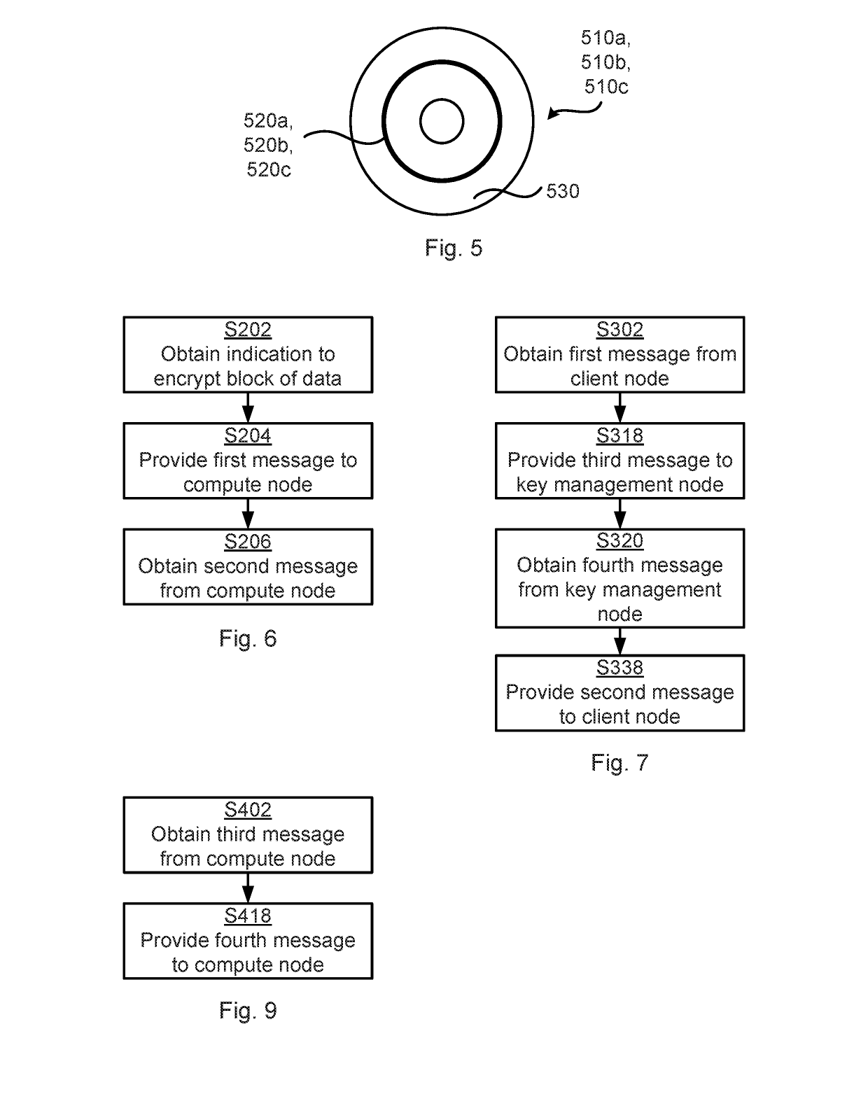

FIG. 5 will he further described below and illustrates a computer program product 510a, 510b, 510c according to an embodiment.

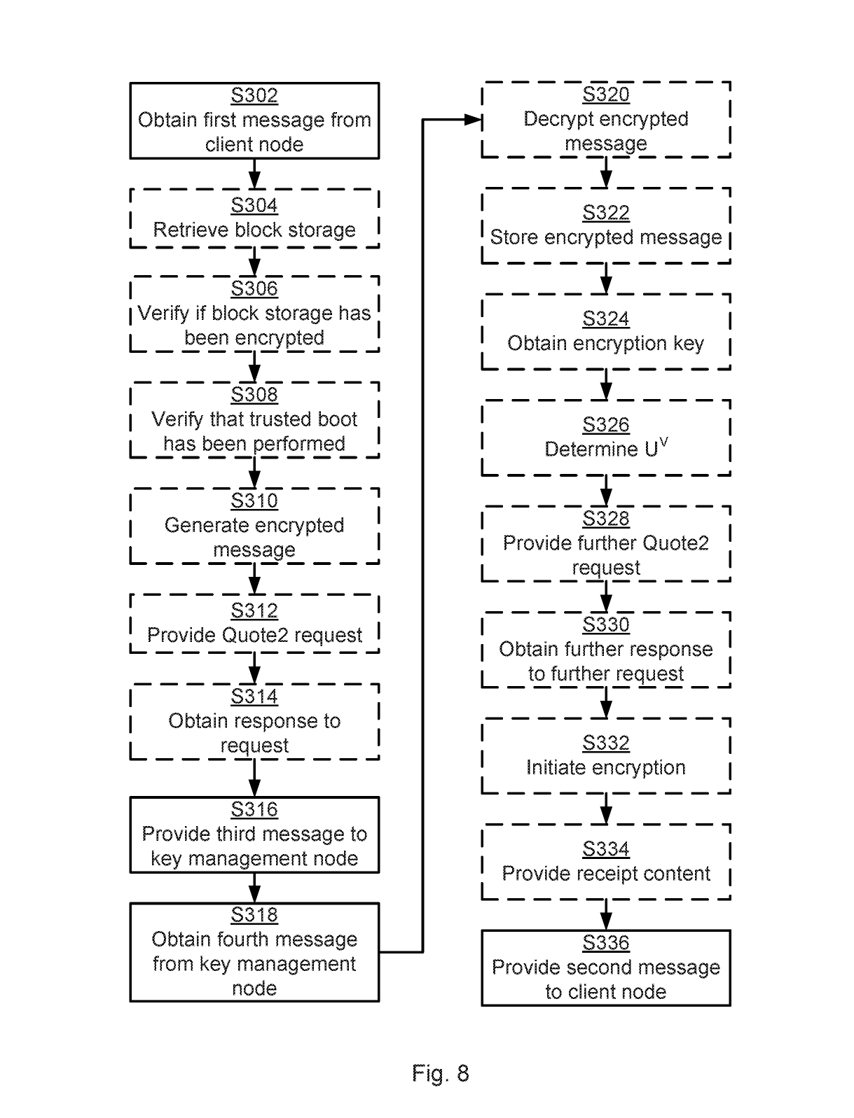

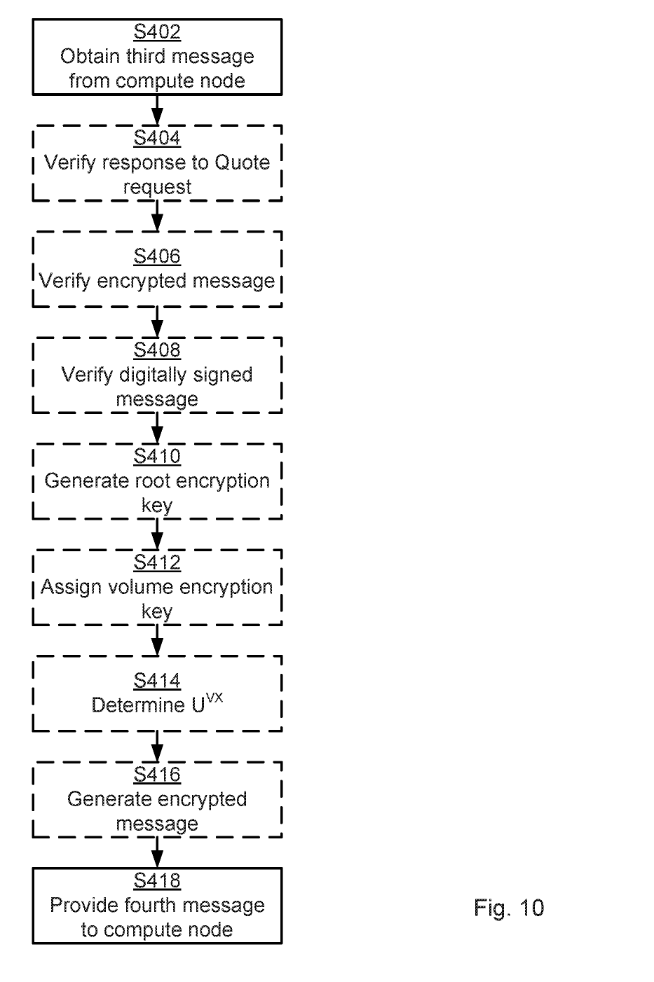

FIG. 6 is a flow chart illustrating an embodiment of a method for verifying setup of encryption of a block of data as performed by the client node 200. FIGS. 7 and 8 are flow charts illustrating embodiments of methods for verifying setup of encryption of a block of data as performed by the compute node 300. FIGS. 9 and 10 are flow charts illustrating embodiments of methods for verifying setup of encryption of a block of data as performed by the key management node 400. The methods are advantageously provided as computer programs 520a, 520b, 520c.

Reference is now made to FIG. 6 illustrating a method for verifying setup of encryption of a block of data as performed by the client node 200 according to an embodiment.

S202: The client node 200 obtains an indication to encrypt the block of data. Even if encryption of the block of data always is enabled, this in itself defines an indirect indication that the block of data is to he encrypted.

S204: The client node 200 provides a first message to a compute node 300. The first message indicates a setup request of a block storage 130 volume, V, to be encrypted. The first message comprises a nonce, N. The nonce, N, could be a cryptographic nonce, a timestamp, etc.

S206: The client node 200 obtains a second message from the compute node 300. The second message comprises the nonce, N, and provides validation that a key management node 400 has taken part in setup of the encryption of the block of data and a cryptographic measurement of the compute node 300, including evidence that the compute node 300 is in a trusted state according to the key management node 400.

In this respect, the block of data may not necessary be available at the client node 200 when the setup of encryption of the block of data is made, but could, for example, become available once proof of an encrypted block storage volume has been validated (as in step S206). Further, the block storage 130 that is attached to the instance of the client node 200 on the compute node 300 can be used to securely store the block of data onto the encrypted block storage 130. Further, the block of data stored by the instance may not be explicatively available at the client node 200, but rather that the client node 200 indicates the block of data to be protected. Further, the herein disclosed embodiments are not limited to any particular size of the block of data, and neither are the herein disclosed embodiments limited to any particular size of the volume. In this respect, once encrypted, the block storage 130 volume, V, may be defined as an encrypted storage volume for the block of data.

Reference is now made to FIG. 7 illustrating a method for verifying setup of encryption of a block of data as performed by the compute node 300 according to an embodiment.

S302: The compute node 300 obtains a first message from the client node 200. As disclosed above with reference to step S204, the first message indicates a setup request of a block storage 130 volume, V, to be encrypted, and comprises a nonce, N.

S316: The compute node 300 provides a third message to a key management node 400. The third message comprises the nonce, N, a unique data storage identity of the block storage 130 volume, V, to be encrypted, and a unique user identity of the client node 200.

S318: The compute node 300 obtains a fourth message from the key management node 400. The fourth message comprises the nonce, N, and an encrypted data storage key, U^{VX}.

S336: The compute node 300 provides a second message to the client node 200. As disclosed above with reference to step S206, the second message comprises the nonce, N, and provides validation that the key management node 400 has taken part in setup of the encryption of the block of data and a cryptographic measurement of the compute node 300, including evidence that the compute node 300 is in a trusted state according to the key management node 400.

Reference is now made to FIG. 9 illustrating a method for verifying setup of encryption of a block of data as performed by the key management node 400 according to an embodiment.

S402: The key management node 400 obtains a third message from a compute node 300. As disclosed above with reference to step S316, the third message comprises a nonce, N, of a client node 200, a unique data storage identity of a block storage 130 volume, V, to be encrypted, and a unique user identity of the client node 200.

S418: The key management node 400 provides a fourth message to the compute node 300. As disclosed above with reference to step S318, the third message comprises the nonce, N, and an encrypted data storage key, U^{VX}.

By using RSA encryption keys in arid the TPM on a compute node 300, proof can be provided to the client device 200 that an encrypted block storage 130 volume, V; is setup on a secure compute node 300.

Proof, in form of signed receipt, is made available to the client device 200 both at the front-end as well as on the encrypted volume itself.

When attaching an encrypted volume, the key management node 300 can obtain a proof that it is a trusted compute node 300 in an authorized state that requests the volume encryption key of a specific client node 200 for a given volume.

Storage of secured volume encryption keys in, possibly unsecure, database makes it possible to avoid unnecessary calls to TPM and the key management node 400 in many re-initialization cases.

An ordinary bind key in combination with NV-RAM data sealed to specific PCR-states and/or protected with a PCR dependent pass-phrase gives the possibility to remotely seal data.

Embodiments relating to further details of verifying setup of encryption of a block of data as performed by the client node 200, the compute node 300, and the key management node 400 will now be disclosed.

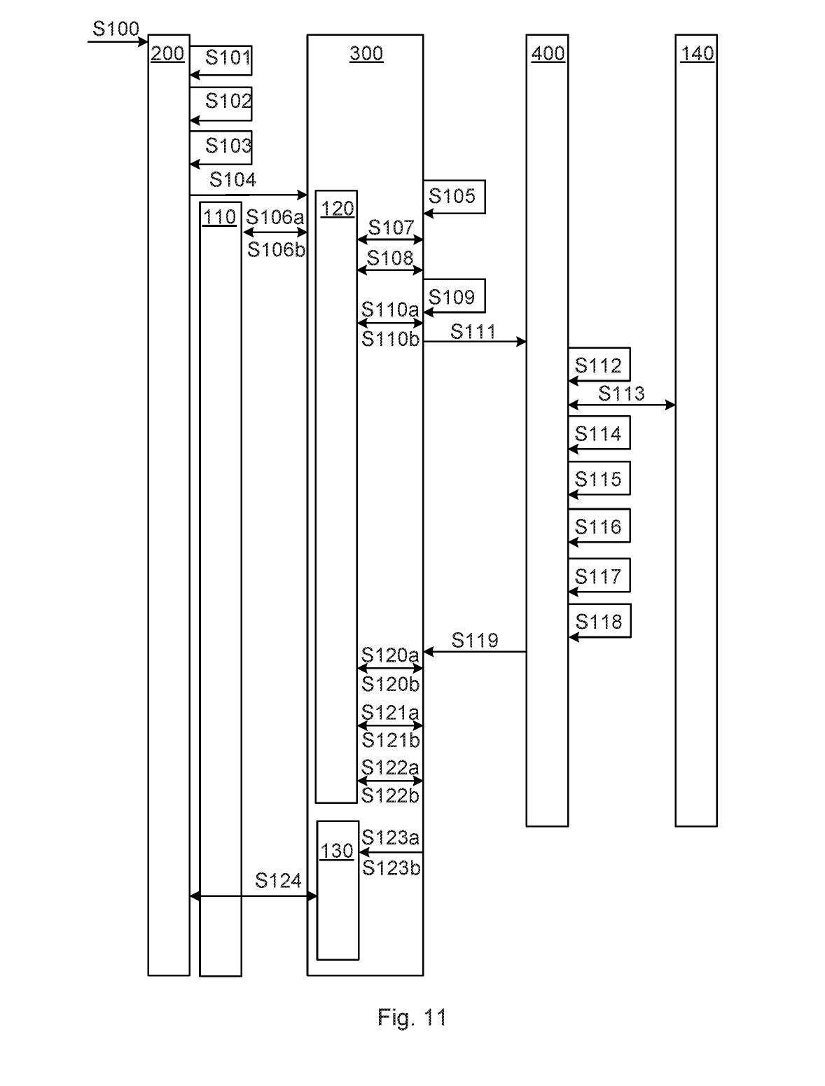

Reference is now made to FIG. 8 illustrating methods for verifying setup of encryption of a block of data as performed by the compute node 300 according to further embodiments, to FIG. 10 illustrating methods for verifying setup of encryption of a block of data as performed by the key management node 400 according to further embodiments, and to FIG. 11 illustrating methods for verifying setup of encryption of a block of data as performed by the client node 200, compute node 300, and the key management node 400 according to further embodiments.

S100: The client node 200 obtains an indication to encrypt the block of data, as in step S202.

S101: For an initial volume encryption setup, client node 200 generates nonce N, which is to be used as proof that encryption of the block of data has indeed been setup.

S102: The client node 200 signs a first message, where the signed first message is denoted M¹, including the nonce. The first message is signed with a private encryption key (such as a private RSA key) of the client node 200. In addition to N, the first message can also include additional information such as a specific platform configuration (PCR) list for a trusted platform module (TPM) quote, and optional a unique volume identity, V^{Id}. Hence, according to an embodiment the first message is digitally signed using a private encryption key of the client node 200 before being provided to the compute node 300 as a digitally signed message M¹.

S103: The client node 200 encrypts AP with a public encryption key such as a public RSA key, where RSA is short for Rivest-Shamir-Adleman) of the key management node 400, where the encrypted first message is denoted M². Hence, according to an embodiment the digitally signed message M¹ is encrypted using a public key of the key management node 400 before being provided to the compute node 300 as an encrypted message M².

S104: The client node 200 sends M² as part of volume attach, VA, to the compute node 300. The compute node 300 thus obtains M² from the client node 200. If M² is not included in the attach message then this indicates that volume encryption already may have been setup and the client node 200 does not request any proof, alternatively volume encryption is not used for the specific volume. The message M² can be mandatory for a new block of data to be encrypted, i.e. where encryption has not yet been setup. Hence, according to an embodiment the first message is provided to the compute node (300) as part of a volume attach, VA, message. Step S104 may be performed as part of above disclosed step S204. Step S104 may be performed as part of above disclosed step S302.

S105: The compute node 300 checks the VA and may find M², indicating a setup request of an encrypted block storage 130 volume, V.

S106: The compute node 300 retrieves the block storage 130 volume, V, from a block storage node. Hence, according to an embodiment the compute node 300, in a step S106a, retrieves the block storage 130 volume, V, from a block storage node. In case M² was not included in the VA message then the block storage 130 volume, V, will be checked if it already is encrypted. Hence, according to an embodiment the compute node 300, in a step S106b, and in a case the first message has not been digitally signed using a private encryption key of the client node 200 and not encrypted using a public key of a key management node 400, verifies whether the block storage 130 volume, V, has already been encrypted or riot.

S107: Prior continuing with volume encryption, the compute node 300 checks its TPM PCR register(s) to ensure that trusted boot has been performed. Hence, according to an embodiment the compute node 300, in a step S308, verifies with the PCR that a trusted boot of the compute node 300 has been performed.

S108: If not already available, the compute node 300 creates a non migratable TPM based bind key, which public part is denoted PK^{Bind}, as well as associated certification information. An encryption key, B, is read from TPM Non-Volatile Random Access Memory (NV-RAM), which is bound to a trusted PCR state of the TPM. The encryption key B is created, such as with a random value, at trusted boot if not already existing. The trusted state may include a passphrase that is used to extend a PCR register prior defining the NV-RAM space. An alternative to using the encryption key, B, for PCR-dependency is to let PK^{Bind} be dependent on the trusted PCR state.

S109: The compute node 300 creates B^{X}=Hash(V^{Id}|U^{Id}|PK^{Bind}|B), where Hash(x) is a hash function of the parameter x. In turn, B^{X} will be encrypted, E(B^{X}), where the encrypted message is denoted E¹, with the public encryption key of the key management node 400. Hence, according to an embodiment the compute node 300, in a step S310, generates an encrypted message E¹ of B^{X} using a public encryption key of the key management node 400, where B^{X}=Hash(V^{Id}|U^{Id}|PK^{Bind}|B), where V^{Id} is a unique identity of the block storage 130 volume, V, where U^{Id} is the unique identity of the client node 300, where PK^{Bind} is a non-migratable TPM based bind key.

S110a, S110b: The compute node 300 makes a Quote2 request. This can be required to provide proof to the key management node 400 that a trusted compute node 300, in an approved PCR state, is requesting the volume encryption key, U^{V}, of the client node 200. The Quote2 request can make use of N^{Q}=Hash(E¹, PK^{Bind}, M² (if existing), U^{Id} and V^{Id}). Denote the quote response Q^{Resp}. If M² is included in the VA, then a second quote request will be made at a later stage in order to provide proof to the client node 200 that an encrypted volume has been initiated. The Quote2 in Step S110a, S110b can be replaced by a CertifyKey command, generating a Certify-KeyInfo certification of PK^{Bind} and using Hash(E¹, M² (if existing), U^{Id} and V^{Id}) as nonce. Hence, according to an embodiment, where the first message is Obtained as a signed and encrypted message, M², the compute node 300, in a step S312, provides a Quote2 request, Q^{Req}, comprising N^{Q}=Hash(E¹, PK^{Bind}, M², U^{Id}, V^{Id}) to the TPM 120; and in return, in a step S314, obtains a response, Q^{Resp}, to the Quote2 request from the TPM 120.

S111: The compute node 300 sends Q^{Resp}, E¹, PK^{Bind}, U^{Id} and V^{Id} and, in the initial case, M² to the key management node 400, which thus obtains this information. Hence, according to an embodiment the third message provided to the key management node 400 comprises Q_{Resp}, E¹, PK^{Bind}, U^{Id} and V^{Id} (and, optionally, M²). Step S111 may be performed as part of above disclosed step S316. Step S111 maybe performed as part of above disclosed step S402.

S112: The key management node 400 will, when existing, decrypt M² in order to obtain the nonce, N. The key management node 400 will also verify Q^{Resp} to ensure that a trusted compute node 300 is requesting U^{V}. When verifying Q^{Resp}, the key management node 400 will validate N^{Q} by determining the same hash, i.e., Hash(E¹, PK^{Bind}, M² (if existing), U^{Id} and V^{Id},), and compare the result to Q^{Resp}. The key management node 400 can now compare the hash of the PCR contents from Q^{Resp} with a white list to make sure that U^{V} is only distributed to an approved and trusted compute node 300. Validation of N^{Q} will also bind the received E¹, PK^{Bind}, M² (if existing), U^{Id} and V^{Id} to the platform state proofed by Q^{Resp}. Hence, according to an embodiment, and where the third message comprises an encrypted message M² originating from the client node 200, the key management node 400 is configured to, in a step S404, verify Q^{Resp}, by determining N^{Q}=Hash(E¹, M², PK^{Bind}, U^{Id}, V^{Id}) and comparing the result thereof to Q^{Resp}.

S113: The key management node 400, if M² was included, retrieves the public encryption key, denoted U^{PUB}, of the client node 200 is retrieved from the user identification node 140 to verify M¹. Hence, according to an embodiment, and where the third message comprises an encrypted message M² originating from the client node 200, the key management node 400 is configured to, in a step S406, verify with a user identification node 140, the encrypted message M² using a public encryption key, U^{PUB}, of the client node 200.

S114: The key management node 400, where applicable, verifies the signature of M¹. If V^{Id} was included in M², the key management node 400 also compares V^{Id} with V^{Id} as sent from the client node 300 in step S111. Hence, according to an embodiment, and where the third message comprises a digitally signed message M¹ originating from the client node 200, the key management node 400 is configured to, in a step S408, verify the digitally signed message M¹.

S115: If not existing, the key management node 400 will create a unique user encryption key, denoted U^{K}, which will be a root key for the client node 200, used to derive other encryption keys. Hence, according to an embodiment the key management node 400 is configured to, in a step S410, generate a root encryption key, U^{K}, for the client node 200.

S116: The key management node 400 assigns a specific volume encryption key, denoted U^{V}, derived from U^{K} and, in relevant cases, V^{Id}. U^{V} is derived such that it later can be recreated for the client ode 200 when verifying a Q^{Resp} message and that it is unique for the volume. Hence, according to an embodiment the key management node 400 is configured to, in a step S412, assign a volume encryption key, U^{V}, derived from U^{K}, such that U^{V} is re-creatable for the client node (200) when verifying a Q^{Resp} message and that U^{V} is unique for the block storage 130 volume, V, to be encrypted.

S117: The key management node 400 decrypts E¹, obtains B^{X} and determines U^{VX}=B^{X} ⊕ U^{V}, where ⊕ denotes bit-wise XOR. Hence, according to an embodiment the key management node 400 is configured to, in a step S414, determine U^{VX}=B^{X}⊕U^{V} between B^{X} and U^{V}.

S118: The key management node 400 uses PK^{Bind} to encrypt U^{VX}, in relevant cases V^{Id}, U^{Id} and optional N when M² was included, encrypted message E(U^{VX}, V^{Id}, U^{Id}, N), denoted E². Hence, according to an embodiment the key management node 400 is configured to, in a step S416, generate an encrypted message E² of U^{VX} using PK^{Bind}.

S119: The key management node 400 provides E² to the compute node 300. Hence, according to an embodiment the fourth message provided to the compute node 300 comprises the encrypted message E², of U^{VX}, where PK^{Bind} has been used to encrypt U^{VX}, and where U^{VX}=B^{X}⊕U^{V}, where ⊕ denotes bit-wise XOR (i.e., exclusive disjunction, or exclusive or) between B^{X} and U^{V}, and where U^{V} is a volume encryption key. Step S119 may be performed as part of above disclosed step S318. Step S119 may be performed as part of above disclosed step S418.

S120a, S120b: The compute node 300 unbinds E² in the TPM and obtains U^{VX}, and in relevant cases V^{Id}, U^{Id}, and optional the nonce N. If available in a database, then steps S110-S119 need not to be performed as long as the same compute node 300 is used and no update of boot software reflected in above used trust bounded PCR-registers or re-initialization of encryption keys has been performed on the compute node 300. Also, since, in relevant cases V^{Id} and U^{Id} are included in E², a sanity check can be made when E² is read from the database to match it to a client node 200 and, in relevant cases, volume. In the case where the same encryption key is re-used for different volumes for the same client node 200, this encryption key also be picked from the database directly, if existing and up to date, thus without any of steps S110-S119 being performed. An alternative mechanism to securely store U^{V} locally is be to use TPM seal. Hence, according to an embodiment the compute node 300 is configured to, in a step S320, decrypt the encrypted message E² to obtain U^{VX}. E² maybe stored in a database for future use, with an index derived as Hash(B^{X}). Hence, according to an embodiment the compute node 300 is configured to, in a step S322, store the encrypted message E² with an index set to Hash(B^{X}).

S121: The compute node 300 uses B, read from TPM NV-RAM, to calculate B^{X}=Hash(V^{Id}|U^{Id}|PK^{Bind}|B) and can then calculate U^{V}=B^{X} ⊕ U^{VX}. Hence, according to an embodiment the compute node 300 is configured to, in a step S324, obtain an encryption key B bound to a trusted PCR state of the TPM 120; and, in a step S326, determine U^{V}=B^{X} ⊕U^{VX}, where B^{X}=Hash(V^{Id}|U^{Id}|PK^{Bind}|B).

S122a, S122b: The compute node 300, in case of an initial volume encryption setup, makes a second TPM quote request, using N as nonce, to the TPM and receives a response comprising a hash of selected PCR contents, Common Alerting Protocol (CAP) version information (optionally), and an Attestation Identity Key (AIK) signature, which covers the data received in the response, as well as the nonce N. Hence, according to an embodiment the compute node 300 is configured to, in a step S328, provide a further Quote2 request, Q^{Req,2}, comprising the nonce, N, to the TPM 120; and, in a step S330, obtain a further response, Q^{Resp2}, to the further Quote2 request from the TPM 120, wherein the further response, Q^{Resp,2}, comprises receipt content, R, the receipt content comprising a cryptographic hash of a trusted PCR content, and signed by the AIK.

S123a, S123b: The compute node 300 initiates encrypted volume, using U^{V}, and writes the receipt contents, denoted R, onto the volume. The receipt contents, R, can also be provided to the client node 200. The receipt contents R can comprise the nonce, N, a hash of selected PCR contents, CAP version information (optionally), AIK signature, AIK public encryption key and an AIK public encryption key certificate. Hence, according to an embodiment the compute node 300 is configured to, in a step S332, initiate encryption of the block storage 130 volume, V, to be encrypted; and, in a step S334, provide the receipt content, R, to the block storage 130 volume, V.

S124: With R written on the block storage 130 volume, V, it can be possible for the running instance on the compute node 300, when the block storage 130 volume, V, has been attach to it, to read and validate the contents R. This provides proof that a setup of an encrypted volume has been initiated and that the setup is performed on a trusted compute node 300, in a state approved by the key management node 400. With N, the client node 200 can verify that the key management node 400 has been used. Inclusion of the nonce, N, blocks a replay attack. The receipt contents, R, with its PCR contents, provides the client device 200 means for verifying the boot state of the compute node 300 and the values can be compared with a white list. Hence, according to an embodiment the second message further comprises a receipt content, R, the receipt content comprising a cryptographic hash of trusted PCR content, signed by an Step S124 may be performed as part of above disclosed step S206. Step S124 may be performed as part of above disclosed step S336.

FIG. 2a schematically illustrates, in terms of a number of functional units, the components of a client node 200 according to an embodiment. Processing circuitry 210 is provided using any combination of one or more of a suitable central processing unit (CPU), multiprocessor, microcontroller, digital signal processor (DSP), etc., capable of executing software instructions stored in a computer program product 410a (as in FIG. 5), e.g. in the form of a storage medium 230. The processing circuitry 210 may further be provided as at least one application specific integrated circuit (ASIC), or field programmable gate array (FPGA).

Particularly, the processing circuitry 210 is configured to cause the client node 200 to perform a set of operations, or steps, S100, S104, S124, S202, S204, S206, as disclosed above. For example, the storage medium 230 may store the set of operations, and the processing circuitry 210 may be configured to retrieve the set of operations from the storage medium 230 to cause the client node 200 to perform the set of operations. The set of operations may be provided as a set of executable instructions. Thus the processing circuitry 210 is thereby arranged to execute methods as herein disclosed.

The storage medium 230 may also comprise persistent storage, which, for example, can be any single one or combination of magnetic memory, optical memory, solid state memory or even remotely mounted memory.

The client node 200 may further comprise a communications interface 220 for communications with at least the compute node 300. As such the communications interface 220 may comprise one or more transmitters and receivers, comprising analogue and digital components.

The processing circuitry 210 controls the general operation of the client node 200 e.g. by sending data and control signals to the communications interface 220 arid the storage medium 230, by receiving data and reports from the communications interface 220, and by retrieving data and instructions from the storage medium 230. Other components, as well as the related functionality, of the client node 200 are omitted in order not to obscure the concepts presented herein.

FIG. 2b schematically illustrates, in terms of a number of functional modules, the components of a client node 200 according to an embodiment. The client node 200 of FIG. 2b comprises a number of functional modules; an obtain module 21oa configured to perform above steps S100, S124, S202, S206, and a provide module 210b configured to perform above steps S104, S204. The client node 200 of FIG. 2b may further comprise a number of optional functional modules. In general terms, each functional module 210a-210b may be implemented in hardware or in software. Preferably, one or more or all functional modules 210a-210b may be implemented by the processing circuitry 210, possibly in cooperation with functional units 220 and/or 230. The processing circuitry 210 may thus be arranged to from the storage medium 230 fetch instructions as provided by a functional module 210a-210b and to execute these instructions, thereby performing the steps of the client node 200 as disclosed above.

FIG. 3a schematically illustrates, in terms of a number of functional units, the components of a compute node 300 according to an embodiment. Processing circuitry 310 is provided using any combination of one or more of a suitable central processing unit (CPU), multiprocessor, microcontroller, digital signal processor (DSP), etc., capable of executing software instructions stored in a computer program product 410b (as in FIG. 5), e.g. in the form of a storage medium 330. The processing circuitry 310 may further be provided as at least one application specific integrated circuit (ASIC), or field programmable gate array (FPGA).

Particularly, the processing circuitry 310 is configured to cause the compute node 300 to perform a set of operations, or steps, S104, S106a, S106b, S107, S109, S110a, S110b, S111, S119, S120a, S120b, S121a, S121b, S122a, S122b, S123a, 123b, S124, S302-S336, as disclosed above. For example, the storage medium 330 may store the set of operations, and the processing circuitry 310 may be configured to retrieve the set of operations from the storage medium 330 to cause the compute node 300 to perform the set of operations. The set of operations may be provided as a set of executable instructions. Thus the processing circuitry 310 is thereby arranged to execute methods as herein disclosed.

The storage medium 330 may also comprise persistent storage, which, for example, can he any single one or combination of magnetic memory, optical memory, solid state memory or even remotely mounted memory.

The compute node 300 may further comprise a communications interface 320 for communications at least with the client node 200 and the key management node 400. As such the communications interface 320 may comprise one or more transmitters and receivers, comprising analogue and digital components.

The processing circuitry 310 controls the general operation of the compute node 300 e.g. by sending data and control signals to the communications interface 320 and the storage medium 330, by receiving data and reports from the communications interface 320, and by retrieving data and instructions from the storage medium 330. Other components, as well as the related functionality, of the compute node 300 are omitted in order not to obscure the concepts presented herein.

FIG. 3b schematically illustrates, in terms of a number of functional modules, the components of a compute node 300 according to an embodiment. The compute node 300 of FIG. 3b comprises a number of functional modules; an obtain module 310a configured to perform above steps S104, S110a, S119, S121a, S122b, S302, S314, S318, S324, S330, and a provide module 310b configured to perform above steps S111, S110a, S122a, S123b, S124, S316, S312, S328, S334, S336. The compute node 300 of FIG. 3b may further comprises a number of optional functional modules, such as any of a retrieve module 310c configured to perform above steps S106a, S304, a verify module 310d configured to perform above steps S106b, S107, S306, S308, a generate module 310e configured to perform above steps S109, S310, a decrypt module 310f configured to perform above steps S120a, S320, a store module 310g configured to perform above steps S120b, S322, a determine module 310h configured to perform above steps S121b, S326, and an initiate module 310j configured to perform above steps S123a, S332. In general terms, each functional module 310a-310j may be implemented in hardware or in software. Preferably, one or more or all functional modules 310a-310j may be implemented by the processing circuitry 310, possibly in cooperation with functional units 320 and/or 330. The processing circuitry 310 may thus be arranged to from the storage medium 330 fetch instructions as provided by a functional module 310a-310j and to execute these instructions, thereby performing the steps of the compute node 300 as disclosed above.

FIG. 4a schematically illustrates, in terms of a number of functional units, the components of a key management node 400 according to an embodiment. Processing circuitry 410 is provided using any combination of one or more of a suitable central processing unit (CPU), multiprocessor, microcontroller, digital signal processor (DSP), etc., capable of executing software instructions stored in a computer program product 410b (as in FIG. 5), e.g. in the form of a storage medium 430. The processing circuitry 410 may further be provided as at least one application specific integrated circuit (ASIC), or field programmable gate array (FPGA).

Particularly, the processing circuitry 410 is configured to cause the key management node 400 to perform a set of operations, or steps, S111-S119, S402-S418, as disclosed above. For example, the storage medium 430 may store the set of operations, and the processing circuitry 410 may be configured to retrieve the set of operations from the storage medium 430 to cause the key management node 400 to perform the set of operations. The set of operations may be provided as a set of executable instructions. Thus the processing circuitry 410 is thereby arranged to execute methods as herein disclosed.

The storage medium 430 may also comprise persistent storage, which, for example, can be any single one or combination of magnetic memory, optical memory, solid state memory or even remotely mounted memory.

The key management node 400 may further comprise a communications interface 320 for communications at least with the compute node 300 and the user identification node 140. As such the communications interface 320 may comprise one or more transmitters and receivers, comprising analogue and digital components.

The processing circuitry 410 controls the general operation of the key management node 400 e.g. by sending data and control signals to the communications interface 320 and the storage medium 430, by receiving data and reports from the communications interface 420, and by retrieving data and instructions from the storage medium 430. Other components, as well as the related functionality, of the key management node 400 are omitted in order not to obscure the concepts presented herein.

FIG. 4b schematically illustrates, in terms of a number of functional modules, the components of a key management node 400 according to an embodiment. The key management node 400 of FIG. 4b comprises a number of functional modules; an obtain module 410a configured to perform above steps S111, S402, and a provide module 410b configured to perform above steps S119, S418. The key management node 400 of FIG. 4b may further comprises a number of optional functional modules, such as any of a verify module 410c configured to perform above steps S112, S113, S114, S404, S406, S408, a generate module 410d configured to perform above steps S115, S410, an assign module 410e configured to perform above steps S116, S412, and a determine module 410f configured to perform above steps S118, S416. In general terms, each functional module 410a-410f may be implemented in hardware or in software. Preferably, one or more or all functional modules 410a-410f may be implemented by the processing circuitry 410, possibly in cooperation with functional units 420 and/or 430. The processing circuitry 410 may thus be arranged to from the storage medium 430 fetch instructions as provided by a functional module 410a-410f and to execute these instructions, thereby performing the steps of the key management node 400 as disclosed above.

FIG. 5 shows one example of a computer program product 510a, 510b, 510c comprising a computer readable storage medium 530. On this computer readable storage medium 530, a computer program 520a can be stored, which computer program 520a can cause the processing circuitry 210 and thereto operatively coupled entities and devices, such as the communications interface 220 and the storage medium 230, to execute methods according to embodiments described herein. The computer program 520a and/or computer program product 510a may thus provide means for performing any steps of the client node 200 as herein disclosed. On this computer readable storage medium 530, a computer program 520b can be stored, which computer program 520b can cause the processing circuitry 310 and thereto operatively coupled entities and devices, such as the communications interface 320 and the storage medium 330, to execute methods according embodiments described herein. The computer program 520b and/or computer program product 510b may thus provide means for performing any steps of the compute node 300 as herein disclosed. On this computer readable storage medium 530, a computer program 520c can be stored, which computer program 520c can cause the processing circuitry 410 and thereto operatively coupled entities and devices, such as the communications interface 420 and the storage medium 430, to execute methods according to embodiments described herein. The computer program 520b and/or computer program product 510b may thus provide means for performing any steps of the key management node 400 as herein disclosed.

In the example of FIG. 5, the computer program product 510a, 510b, 510c is illustrated as an optical disc, such as a CD (compact disc) or a DVD (digital versatile disc) or a Iglu-Ray disc. The computer program product 510a, 510b, 510c could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while w the computer program 520a, 520b, 520c is here schematically shown as a track on the depicted optical disk, the computer program 520a, 520b, 520c can be stored in any way which is suitable for the computer program product 510a, 510b, 510c.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1. A method for verifying setup of encryption of a block of data, the method being performed by a client node, the method comprising:
obtaining an indication to encrypt the block of data;
providing a first message to a compute node indicating a setup request of a block storage volume, V, to be encrypted, wherein the first message comprises a nonce, N; and
obtaining a second message from the compute node, wherein the second message comprises the nonce, N, and provides validation that a key management node has taken part in setup of the encryption of the block of data and a cryptographic measurement of the compute node, including evidence that the compute node is in a trusted state according to the key management node.

2. The method according to claim 1, wherein the first message is digitally signed using a private encryption key of the client node before being provided to the compute node as a digitally signed message M¹.

3. The method according to claim 2, wherein the digitally signed message M¹ is encrypted using a public key of a key management node before being provided to the compute node as an encrypted message M².

4. The method according to claim 1, wherein the first message is provided to the compute node as part of a volume attach (VA) message.

5. The method according to claim 1, wherein the second message further comprises a receipt content, R, the receipt content comprising a cryptographic hash of trusted platform configuration register (PCR) content, signed by an Attestation Identity Key (AIK).

6. A method for verifying setup of encryption of a block of data, the method being performed by a compute node, the method comprising:
obtaining a first message from a client node, wherein the first message indicates a setup request of a block storage volume, V, to be encrypted, and wherein the first message comprises a nonce, N;
providing a third message to a key management node, wherein the third message comprises the nonce, N, a unique data storage identity of the block storage volume, V, to be encrypted, and a unique user identity of the client node;
obtaining a fourth message from the key management node, wherein the fourth message comprises the nonce, N, and an encrypted data storage key, U^{VX};
providing a second message to the client node, wherein the second message comprises the nonce, N, and provides validation that the key management node has taken part in setup of the encryption of the block of data and a cryptographic measurement of the compute node, including evidence that the compute node is in a trusted state according to the key management node.

7. The method according to claim 6, wherein the first message is obtained from the client node as part of a volume attach (VA) message.

8. The method according to claim 6, further comprising:
retrieving the block storage volume, V, from a block storage node.

9. The method according to claim 8, further comprising, in a case the first message has not been digitally signed using a private encryption key of the client node and not encrypted using a public key of a key management node:
verifying whether the block storage volume, V, has already been encrypted or not.

10. The method according to claim 6, further comprising:
verifying, with a platform configuration register (PCR) that a trusted boot of the compute node has been performed.

11. The method according to claim 6, further comprising:
generating an encrypted message E¹ of B^{X} using a public encryption key of the key management node, where B^{X}=Hash(V^{Id}|U^{Id}|PK^{Bind}|B), where V^{Id} is a unique identity of the block storage volume, V, where U^{Id} is the unique identity of the client node, and where PK^{Bind} is a non-migratable trusted platform module (TPM) based bind key.

12. The method according to claim 11, wherein the first message is obtained as a signed and encrypted message, M², the method further comprising:
providing a Quote2 request, Q^{Req}, comprising N^{Q}=Hash(E¹, PK^{Bind}, M², U^{Id}, V^{Id}) to the TPM; and
obtaining a response, Q^{Resp}, to the Quote2 request from the TPM.

13. The method according to claim 12, wherein the third message provided to the key management node comprises Q^{Resp}, E¹, PK^{Bind}, U^{Id} and V^{Id}.

14. The method according to claim 11, wherein the fourth message comprises an encrypted message E² of U^{VX}, where PK^{Bind} has been used to encrypt U^{VX}, and where U^{VX}=B^{X}⊕U^{V}, where ⊕ denotes bit-wise XOR between B^{X} and U^{V}, and where U^{V} is a volume encryption key.

15. The method according to claim 14, further comprising:
decrypting the encrypted message E² to obtain U^{VX}; and/or
storing the encrypted message E² with an index set to Hash(B^{X}).

16. The method according to claim 15, further comprising:
obtaining an encryption key B bound to a trusted platform configuration register (PCR) state of a trusted platform module (TPM); and
determining U^{V}=B^{X}⊕U^{VX}, where B^{X}=Hash(V^{Id}|U^{Id}|PK^{Bind}|B).

17. The method according to claim 6, further comprising:
providing a further Quote2 request, Q^{Req,2}, comprising the nonce, N, to the TPM; and
obtaining a further response, Q^{Resp,2}, to the further Quote2 request from the TPM, wherein the further response, Q^{Resp,2}, comprises receipt content, R, the receipt content comprising a cryptographic hash of a trusted platform configuration register (PCR) content, and signed by an Attestation Identity Key (AIK).

18. The method according to claim 17, further comprising:
initiating encryption of the block storage volume, V, to be encrypted; and
providing the receipt content, R, to the block storage volume, V.

19. The method according to claim 18, wherein the second message provided to the client node comprises the receipt content, R.

20. A method for verifying setup of encryption of a block of data, the method being performed by a key management node, the method comprising:
obtaining a third message from a compute node, wherein the third message comprises a nonce, N, of a client node, a unique data storage identity of a block storage volume, V, to be encrypted, and a unique user identity of the client node; and
providing a fourth message to the compute node, wherein the fourth message comprises the nonce, N, and an encrypted data storage key, U^{VX}.

21. The method according to claim 20, wherein the third message obtained from the compute node comprises Q^{Resp}, E¹, PK^{Bind}, U^{Id} and V^{Id}, where Q^{Resp} is response to a Quote2 request made by the compute node to a trusted platform module (TPM), where E¹ is an encrypted message E¹ of B^{X} using a public encryption key of the key management node, where B^{X}=Hash(V^{Id}|U^{Id}|PK^{Bind}|B), where V^{Id} is a unique identity of the block storage volume, V, where U^{Id} is a unique user identity, where PK^{Bind} is a non-migratable TPM based bind key, and where B is an encryption key bound to a trusted platform configuration register (PCR) state of the TPM.

22. The method according to claim 20, wherein the third message comprises an encrypted message M² originating from the client node, the method further comprising:
verifying Q^{Resp by} determining N^{Q}=Hash(E¹, M², PK^{Bind}, U^{Id}, V^{Id}) and comparing the result thereof to Q^{Resp}.

23. The method according to claim 20, wherein the third message comprises an encrypted message M² originating from the client node, the method further comprising:
verifying, with a user identification node, the encrypted message M² using a public encryption key, U^{PUB}, of the client node.

24. The method according to claim 20, wherein the third message comprises a digitally signed message M¹ originating from the client node, the method further comprising:
verifying the digitally signed message M¹.

25. The method according to claim 20, further comprising:
generating a root encryption key, U^{K}, for the client node.

26. The method according to claim 25, further comprising:
assigning a volume encryption key, U^{V}, derived from U^{K}, such that U^{V} is re-creatable for the client node when verifying a Q^{Resp} message and that U^{V} is unique for the block storage volume, V, to be encrypted.

27. The method according to claim 26, further comprising:
determining U^{VX}=B^{X}⊕U^{V}, where ⊕ denotes bit-wise XOR, between B^{X} and U^{V}.

28. The method according to claim 27, further comprising:
generating an encrypted message E² of U^{VX} using PK^{Bind}.

29. The method according to claim 28, wherein the fourth message provided to the compute node comprises the encrypted message E².

30. A client node for verifying setup of encryption of a block of data, the client node comprising processing circuitry, the processing circuitry being configured to cause the client node to:
obtain an indication to encrypt the block of data;
provide a first message to a compute node indicating a setup request of a block storage volume, V, to be encrypted, wherein the first message comprises a nonce, N; and
obtain a second message from the compute node, wherein the second message comprises the nonce, N, and provides validation that a key management node has taken part in setup of the encryption of the block of data and a cryptographic measurement of the compute node, including evidence that the compute node is in a trusted state according to the key management node.

31. A compute node for verifying setup of encryption of a block of data, the compute node comprising processing circuitry, the processing circuitry being configured to cause the compute node to:
obtain a first message from a client node, wherein the first message indicates a setup request of a block storage volume, V, to be encrypted, and wherein the first message comprises a nonce, N;
provide a third message to a key management node, wherein the third message comprises the nonce, N, a unique data storage identity of the block storage volume, V, to be encrypted, and a unique user identity of the client node;
obtain a fourth message from the key management node, wherein the fourth message comprises the nonce, N, and an encrypted data storage key, U^{VX};
provide a second message to the client node, wherein the second message comprises the nonce, N, and provides validation that the key management node has taken part in setup of the encryption of the block of data and a cryptographic measurement of the compute node, including evidence that the compute node is in a trusted state according to the key management node.

32. A key management node for verifying setup of encryption of a block of data, the key management node comprising processing circuitry, the processing circuitry being configured to cause the key management node to:
obtain a third message from a compute node, wherein the third message comprises a nonce, N, of a client node, a unique data storage identity of a block storage volume, V, to be encrypted, and a unique user identity of the client node; and
provide a fourth message to the compute node, wherein the fourth message comprises the nonce, N, and an encrypted data storage key, U^{VX}.

33. A nontransitory computer readable storage medium comprising a computer program for verifying setup of encryption of a block of data, the computer program comprising computer code which, when run on processing circuitry of a client node, causes the client node to:
obtain an indication to encrypt the block of data;
provide a first message to a compute node indicating a setup request of a block storage volume, V, to be encrypted, wherein the first message comprises a nonce, N; and
obtain a second message from the compute node, wherein the second message comprises the nonce, N, and provides validation that a key management node has taken part in setup of the encryption of the block of data and a cryptographic measurement of the compute node, including evidence that the compute node is in a trusted state according to the key management node.

34. A nontransitory computer readable storage medium comprising a computer program for verifying setup of encryption of a block of data, the computer program comprising computer code which, when run on processing circuitry of a compute node, causes the compute node to:
obtain a first message from a client node, wherein the first message indicates a setup request of a block storage volume, V, to be encrypted, and wherein the first message comprises a nonce, N;
provide a third message to a key management node, wherein the third message comprises the nonce, N, a unique data storage identity of the block storage volume, V, to be encrypted, and a unique user identity of the client node;
obtain a fourth message from the key management node, wherein the fourth message comprises the nonce, N, and an encrypted data storage key, U^{VX};
provide a second message to the client node, wherein the second message comprises the nonce, N, and provides validation that the key management node has taken part in setup of the encryption of the block of data and a cryptographic measurement of the compute node, including evidence that the compute node is in a trusted state according to the key management node.

35. A nontransitory computer readable storage medium comprising a computer program for verifying setup of encryption of a block of data, the computer program comprising computer code which, when run on processing circuitry of a key management node, causes the key management node to:
obtain a third message from a compute node, wherein the third message comprises a nonce, N, of a client node, a unique data storage identity of a block storage volume, V, to be encrypted, and a unique user identity of the client node; and
provide a fourth message to the compute node, wherein the fourth message comprises the nonce, N, and an encrypted data storage key, U^{VX}.

36. (canceled)
